(19) United States
(12) Patent Application Publication
(10) Pub. No.: US 2010/0321816 A1
(43) Pub. Date: Dec. 23, 2010

(54) MAGNETIC HEAD AND DISK APPARATUS PROVIDED WITH THE SAME

(75) Inventor: Kazuhiro SAITO, Hino-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/759,612

(22) Filed: Apr. 13, 2010

(30) Foreign Application Priority Data
Jun. 23, 2009 (JP) 2009-148874

(51) Int. Cl. G11B 5/02

(52) U.S. Cl. 360/59; G9B/5.026

(57) ABSTRACT

According to an embodiment, a magnetic head of a disk apparatus includes a recording element, a reproduction element, and a heater configured to thermally expand the elements toward the recording medium side. The recording element and reproduction element are configured in such a manner that when a recording current of an amplitude less than or equal to a predetermined amplitude is applied to the recording element, a distance between the recording element and the recording medium surface becomes greater than a distance between the reproduction element and recording medium surface, and when a recording current of an amplitude exceeding the predetermined amplitude is applied to the recording element, the distance between the recording element and the recording medium surface becomes less than the distance between a surface of the reproduction element and the recording medium surface.

### CROSS-REFERENCE TO RELATED APPLICATIONS

This application is based upon and claims the benefit of priority from Japanese Patent Application No. 2009-148874, filed Jun. 23, 2009, the entire contents of which are incorporated herein by reference.

### BACKGROUND

1. Field

An embodiment of the present invention relates to a magnetic head used in a disk apparatus, and disk apparatus provided with the magnetic head.

2. Description of the Related Art

As a disk apparatus, for example, a magnetic disk drive is provided with a magnetic disk arranged in a case, spindle motor configured to support and rotate the magnetic disk, magnetic head configured to read/write information from/to the magnetic disk, and carriage assembly configured to support the magnetic head movably with respect to the magnetic disk. The magnetic head includes a slider attached to a suspension of the carriage assembly, and head section provided on the slider, and the head section is configured to include a recording element for writing, and reproduction element for reading.

In recent years, in order to realize high recording density, large capacity or miniaturization of the magnetic disk apparatus, a magnetic head for vertical magnetic recording is proposed. In such a magnetic head, the recording element includes a main magnetic pole configured to generate a vertical magnetic field, return magnetic pole arranged on the trailing side of the main magnetic pole with a write gap held between itself and the main magnetic pole, and configured to close the magnetic path between itself and the magnetic disk, and coil configured to make magnetic flux flow through the main magnetic pole. Further, the magnetic head is provided with a heater for heating configured to adjust the flying height of the magnetic head by thermally expanding the recording element and reproduction element.

A magnetic head is proposed in which a distance between the main magnetic pole of the recording element and magnetic disk is less than a distance between the reproduction element and magnetic disk. In this case, the main magnetic pole section of the recording element, and reproduction element are configured in such a manner that when the main magnetic pole section and reproduction element are heated by the heater, both the main magnetic pole section and reproduction element protrude to the similar degree to approach the disk. In order to read a recorded signal from the magnetic disk with a better signal-to-noise ratio, it is desirable that the MR head section of the reproduction element be made close as possible to the magnetic disk. For that purpose, although the whole element is heated by the heater, and the reproduction element is caused to protrude toward the magnetic disk side, the main magnetic pole section of the recording element also protrudes in the same manner to come into contact with the magnetic disk earlier, and hence the reproduction element cannot be made closer to the magnetic disk any more.

As means for solving such a problem, as disclosed in, for example, Jpn. Pat. Appln. KOKAI Publication No. 2008-269742, a magnetic head provided with thermal expansion characteristics in which, when the magnetic head is heated by the heater, the reproduction head protrudes by an amount greater than that of the main magnetic pole of the recording element is proposed.

However, in the case of the magnetic head provided with the above-mentioned thermal expansion characteristics, when the main magnetic pole of the recording head is excited to carry out a recording operation, even if the head is heated by the heater, the protrusion amount of the reproduction element is greater than the main magnetic pole of the recording head, the recording head cannot be made sufficiently close to the magnetic disk, and hence it is difficult to obtain a sufficient signal-to-noise ratio.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an HDD according to an embodiment of the present invention;

FIG. 2 is an exemplary side view showing a magnetic head and suspension of the HDD;

FIG. 3 is an exemplary perspective view showing the disk-facing surface side of a slider of the magnetic head;

FIG. 4 is an exemplary cross-sectional view showing the magnetic head and suspension in an enlarging manner;

FIG. 5 is an exemplary cross-sectional view showing a head section of the magnetic head in an enlarging manner;

FIG. 6 is an exemplary cross-sectional view showing the head section in a state where the main magnetic pole is thermally expanded by current application in an enlarging manner;

FIG. 7 is an exemplary perspective view showing a rod-shaped body processed from a wafer in which a plurality of magnetic heads are incorporated to a state where a plurality of sliders are arranged thereon in a line; and

FIG. 8 is an exemplary cross-sectional view showing the head section in a state where protrusion heights of the main magnetic pole of the magnetic head, and reproduction element become identical with each other by enlarging the head section.

### DETAILED DESCRIPTION

Various embodiments according to the invention will be described hereinafter with reference to the accompanying drawings. In general, according to one embodiment of the invention, a magnetic head comprises: a recording element configured to record information on a recording medium; a reproduction element configured to reproduce recorded information from the recording medium; and a heater configured to heat the recording element and reproduction element and cause the elements to thermally expand toward the recording medium side, the recording element and reproduction element being configured in such a manner that when a recording current of an amplitude less than or equal to a predetermined amplitude is applied to the recording element, a distance between the recording element and the recording medium surface becomes greater than a distance between the reproduction element and recording medium surface, and when a recording current of an amplitude exceeding the predetermined amplitude is applied to the recording element, the distance between the recording element and the recording medium surface becomes less than the distance between a surface of the reproduction element and the recording medium surface.

An embodiment in which a disk apparatus according to the present invention is applied to a hard disk drive (HDD) will be described below in detail while referring to the drawings.

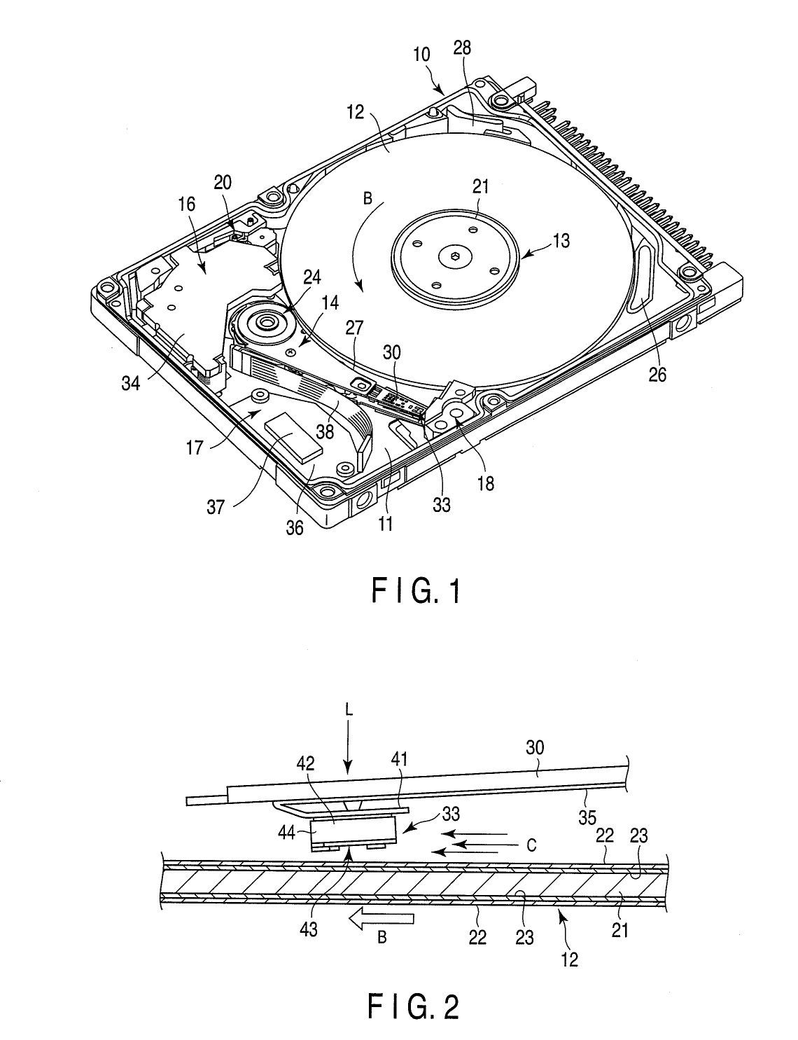

FIG. 1 shows the inner structure of the HDD with a top cover thereof removed, and FIG. 2 shows a magnetic head in the flying state. As shown in FIG. 1, the HDD is provided with a housing 10. The housing 10 includes a base 11 of a rectangular box-shape with an opening in the top surface thereof, and a top cover (not shown) of a rectangular plate-shape. The top cover is fastened to the base by a plurality of screws, and closes the upper end opening of the base. The inside of the housing 10 is kept airtight, and ventilation of air to/from the outside is enabled only through a respiration filter 26. The base 11 and top cover are formed of a metallic material such as aluminum, iron, stainless steel, cold-rolled carbon steel plate or the like.

A magnetic disk 12 serving as a recording medium, and a mechanism section are provided on the base 11. The mechanism section comprises a spindle motor 13 configured to support and rotate the magnetic disk 12, a plurality of, for example, two magnetic heads 33 configured to record/reproduce information on/from the magnetic disk 12, a head actuator 14 configured to support these magnetic heads 33 movably with respect to the surface of the magnetic disk 12, and a voice coil motor (VCM) 16 configured to rotate and position the head actuator. Further, on the base 11 are provided a ramp load mechanism 18 configured to, when the magnetic head 33 has moved to the outer periphery of the magnetic disk, hold the magnetic head 33 at an unloaded position separate from the magnetic disk 12, an inertial latch mechanism 20 configured to, when a shock or the like is applied to the HDD, hold the head actuator 14 at a retracted position, and a board unit 17 on which electronic components such as a preamplifier, head IC, and the like are mounted.

To the outer surface of the bottom wall of the base 11, a control circuit board (not shown) configured to control the operations of the spindle motor 13, VCM 16, and magnetic head 33 through the board unit 17 is attached by screws.

As shown in FIGS. 1 and 2, the magnetic disk 12 is constituted as a vertical two-layer film medium. The magnetic disk 12 includes a substrate 21 constituted of a non-magnetic material formed into a disk-shape with, for example, a diameter of about 2.5 inches. A soft magnetic layer 23 serving as a foundation layer called a soft magnetic underlayer is formed on each surface of the substrate 21, a vertical magnetic recording layer 22 provided with magnetic anisotropy in the direction perpendicular to the disk surface is laid on the soft magnetic layer 23 in sequence, and a protective film (not shown) is further formed thereon.

As shown in FIG. 1, the magnetic disk 12 is coaxially fitted on a hub of the spindle motor 13, and is clamped by a clamp spring 21 screw-fixed to an upper end of the hub, whereby the magnetic disk 12 is fixed to the hub. The magnetic disk 12 is rotated in the direction of the arrow B at a predetermined speed by the spindle motor 13 serving as a drive motor.

The head actuator 14 comprises a bearing section 24 fixed on the bottom wall of the base 11, and a plurality of arms 27 extended from the bearing section 24. These arms 27 are arranged parallel to the surface of the magnetic disk 12 with a predetermined gap held between them, and are extended from the bearing section 24 in the same direction. The head actuator 14 is provided with thin and elongate plate-shaped suspensions 30 which are elastically deformable. The suspension 30 is fixed to the distal end of the arm 27 at a proximal end thereof by spot welding or calking, and is extended from the arm. Each suspension 30 may be formed integral with the corresponding arm 27. The arm 27 and suspension 30 constitute a head suspension, and the head suspension and magnetic head 33 constitute a head suspension assembly.

As shown in FIG. 2, each magnetic head 33 includes a slider 42 with a substantially rectangular shape, and head section 44 for recording/reproduction provided at an outflow end of the slider. The magnetic head 33 is fixed to a gimbal spring 41 provided at the distal end of the suspension 30. A head load L directed to the surface of the magnetic disk 12 is applied to each magnetic head 33 by the elasticity of the suspension 30. The two arms 27 are positioned parallel to each other with a predetermined gap held between them, and the suspensions 30 and magnetic heads 33 attached to the arms are positioned opposed to each other with the magnetic disk 12 interposed between them.

Each magnetic head 33 is electrically connected to a main FPC 38 to be described later through a relay flexible printed circuit board (relay FPC) 35 fixed to the suspension 30 and arm 27.

As shown in FIG. 1, the board unit 17 includes an FPC main body 36 constituted of a flexible printed circuit board, and main FPC 38 extended from the FPC main body. The FPC main body 36 is fixed on the bottom surface of the base 11. Electronic components including the preamplifier 37, and head IC are mounted on the FPC main body 36. The extension end of the main FPC 38 is connected to the head actuator 14, and is further connected to the magnetic head 33 through each FPC 35.

The VCM 16 includes a support frame (not shown) extended from the bearing section 24 in the direction opposite to the arm 27, and voice coil supported by the support frame. In the state where the head actuator 14 is incorporated in the base 11, the voice coil is positioned between a pair of yokes 34 fixed on the base 11, and constitutes the VCM 16 together with these yokes and a magnet fixed to the yokes.

By applying a current to the voice coil in the state where the magnetic disk 12 is rotated, the head actuator 14 is rotated, and the magnetic head 33 is moved to a desired track on the magnetic disk 12, and is positioned thereon. At this time, the magnetic head 33 is moved in the radial direction of the magnetic disk 12 between the inner circumferential section and outer circumferential section of the magnetic disk.

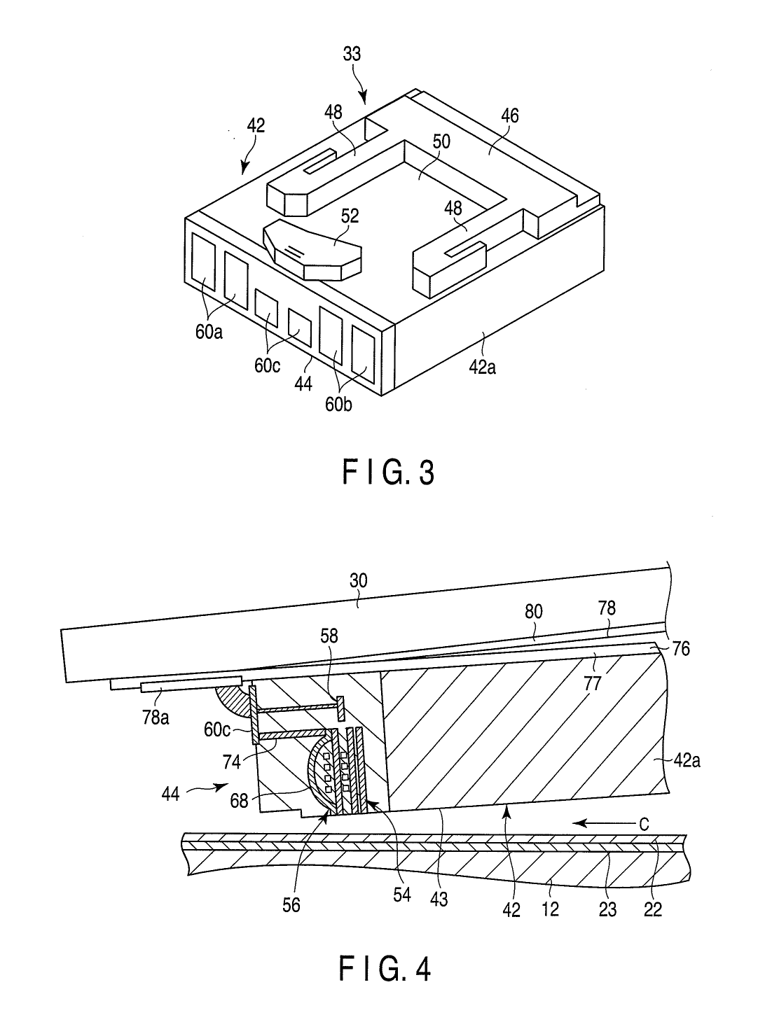

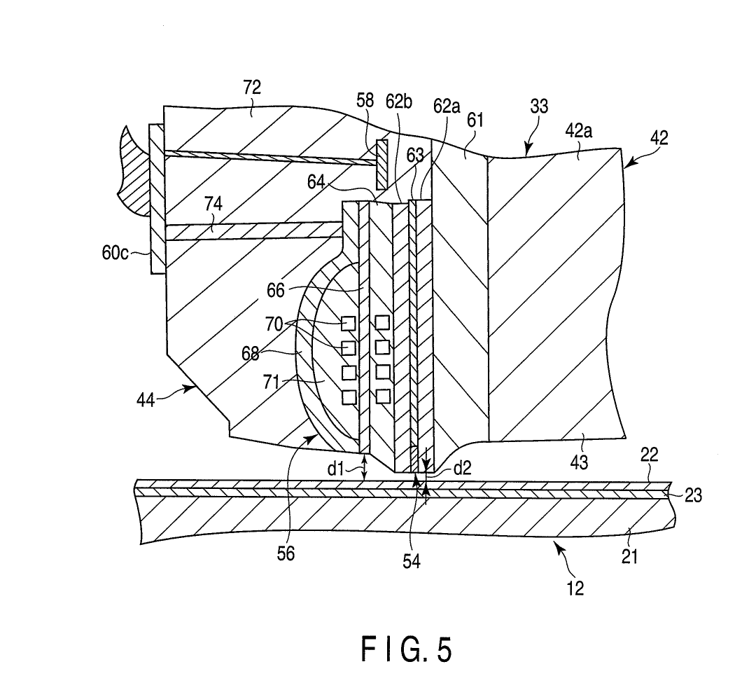

Then, the configuration of the magnetic head 33 will be described below in detail. FIG. 3 is a perspective view showing the slider of the magnetic head, FIG. 4 is a cross-sectional view of the slider, and FIG. 5 is a cross-sectional view showing the head section in an enlarging manner.

As shown in FIGS. 2 to 4, the magnetic head 33 is configured as a flying head, and includes a slider 42 formed into a shape of a substantially rectangular parallelepiped, and a head section 44 formed on the end face on the outflow end side of the slider. The slider 42 includes a substrate section 42a formed of, for example, a sintered body of alumina and titanium carbide (ALTIC), and head section 44 formed of a thin film. The resistance of the substrate section 42a has a relatively low resistance value of several tens Q.

The slider 42 has a rectangular disk-facing surface (air-bearing surface [ABS]) 43 opposed to the surface of the magnetic disk 12. The slider 42 is floated over the disk surface by an airflow C (FIGS. 2 and 4) generated between the disk surface and disk-facing surface 43 by the rotation of the magnetic disk 12. The direction of the airflow C coincides with the rotational direction B of the magnetic disk 12. The slider 42 is arranged in such a manner that the longitudinal direction of the disk-facing surface 43 substantially coincides with the direction of the airflow C with respect to the magnetic disk 12 surface.

As shown in FIG. 3, a substantially rectangular leading step 46 and a pair of side steps 48 which are configured to generate a positive pressure are provided on the disk-facing surface 43 of the slider 42 in a protruding manner. The side steps 48 making a pair extend along long sides of the disk-facing surface, and are opposed to each other with an interval held between them. The side steps 48 each extend from the leading step 46 toward the outflow end side of the slider 42. The leading step 46 and the side steps 48 are arranged symmetrical with respect to the central axis line of the slider 42, and are formed, as a whole, into a substantially U-shaped form in which the inflow side is closed, and which is opened to the outflow side.

A negative-pressure cavity 50 formed of a recess is formed in the substantially central part of the disk-facing surface 43 and defined by the pair of side steps 48 and leading step 46. The negative-pressure cavity 50 is formed on the outflow end side of the leading step 46, and is opened to the outflow end side. By providing the negative-pressure cavity 50, it is possible to generate a negative pressure in the central part of the disk-facing surface 43 at all the yaw angles realized by the HDD.

The slider 42 includes a trailing step 52 with a substantially rectangular shape provided at an end part of the disk-facing surface 43 on the outflow side with respect to the direction of the airflow C, in a protruding manner. The trailing step 52 is positioned on the downstream side of the negative-pressure cavity 50 with respect to the direction of the airflow C, and is positioned in the substantially central part of the disk-facing surface 43 in the width direction.

As shown in FIGS. 3 and 4, the head section 44 comprises a reproduction element 54 formed by a thin-film process, recording element 56, a plurality of metallic films constituting wiring, and heater 58 configured to heat and thermally expand a part of the head section, and cause the part to protrude toward the magnetic disk surface. Further, the head section 44 includes a plurality of, for example, six terminals 60a, 60b, and 60c configured to electrically connect the reproduction element 54, recording element 56, and heater 58 to the outside, and these terminals are provided on the end face of the head section 44 in an exposed state.

Specifically, an insulating layer 61 is formed on the end face of the substrate 42a on the trailing end side thereof are formed. On the insulating layer 61 are formed a lower shield layer 62a provided with a soft magnetic property, gap film 63 constituted of alumina or the like, magneto-resistive effect element (MR element) serving as the reproduction element 54, and a pair of terminals (not shown) configured to derive an electrical signal from the reproduction element. An upper shield layer 62b having a soft magnetic property is formed on the gap film 63. An upper insulating film 64 is formed on the upper shield layer 62b. The other end face of each of the lower shield layer 62a, upper shield layer 62b, and reproduction element 54 is exposed at the disk-facing surface 43 of the slider 42. The reproduction element 54 reproduces information recorded on the magnetic disk 12.

The recording element 56 is provided on the trailing end of the slider 42 with respect to the reproduction element 54. The recording element 56 is configured as a magnetic monopole head. The recording element 56 includes a main magnetic pole 66 configured to apply a recording magnetic field perpendicular to the magnetic disk 12 thereto, and constituted of a soft magnetic material having high magnetic permeability, and high saturation magnetic flux density, and return magnetic pole 68 arranged on the trailing side of the main magnetic pole 66, and configured to efficiently close the magnetic path through a soft magnetic layer 23 directly under the main magnetic pole. A recording coil 70 configured to excite the main magnetic pole 66 when a recording signal is written to the magnetic disk 12 is wound around the main magnetic pole 66. The main magnetic pole 66 is formed on the upper insulating film 64. An insulating film 71 is formed on the main magnetic pole 66. The return magnetic pole 68 is formed on this insulating film. The main magnetic pole 66 extends in a direction perpendicular to the surface of the magnetic disk 12, lower end face of the main magnetic pole 66 on the magnetic disk side is exposed at the disk-facing surface 43, and is opposed to the surface of the magnetic disk 12.

In order to protect and insulate these reproduction element 54, recording element 56, and shield layers, a protective insulating film 72 constituted of alumina or the like is formed to cover these elements. The protective insulating film 72 constitutes an outer shape of the head section 44. Inside the protective insulating film 72, the heater 58 constituted of a metallic film is formed, and is positioned in the vicinity of a part above the recording element 56 and reproduction element 54. In this embodiment, the heater 58 is a single heater configured to simultaneously heat and thermally expand the recording element 56 and reproduction element 54.

The thermal expansion coefficient of the recording element 56 is made substantially greater than or equal to the thermal expansion coefficient of the reproduction element 54 including the upper shield layer, and lower shield layer. As shown in FIGS. 4 and 5, in the state where a recording current less than or equal to a recording current (Iw1) of a predetermined amplitude is applied to the recording coil 70, state where no recording current is applied to the recording coil 70 like at the reproduction time, or state where no current is made to flow through the heater 58, the reproduction element 56 protrudes toward the magnetic disk 12 side to be closer to the magnetic disk than the recording element 56. That is, as shown in FIG. 5, the recording element 56 and reproduction element 54 are provided in such a manner that a distance d1 between the recording element 56 and disk surface is greater than a distance d2 between the reproduction element 54 and disk surface, whereby the recording element 56 is provided in a retracting manner.

It should be noted that, FIG. 5 shows the state where the heater 58 is energized to heat the reproduction element 54 and recording element 56, and hence the reproduction element 54 and recording element 56 are caused to protrude toward the magnetic disk 12 surface. As described above, even in the state where the reproduction element 54 and recording element 56 are heated and expanded, the reproduction element 54 more protrudes to be closer to the magnetic disk 12 than the recording element 56.

Further, as will be described later, at the time of a recording operation to be carried out by the recording element 56, when a recording current (Iw2) with an amplitude exceeding the recording current (Iw1) with a predetermined amplitude is applied to the recording coil 70, a vertical magnetic field is applied from the main magnetic pole 66, the main magnetic pole is heated, the recording element 56 is made to protrude to be closer to the magnetic disk 12 surface side than the reproduction element 54. In this state, a magnetic signal corresponding to the recording current is written from the main magnetic pole 66 to the recording layer 22 of the magnetic disk 12.

As shown in FIGS. 3 to 5, on the outer surface of the protective insulating film 72, i.e., on the trailing side end face, six terminals 60a, 60b, and 60c are formed. Further, a plurality of metallic films (not shown) constituting the wiring are formed, and the reproduction element 54 is electrically connected to the pair of terminals 60a through the metallic films. The main magnetic pole 66 of the recording element 56 is electrically connected to one of the terminals 60b through the metallic film, and return magnetic pole 68 is electrically connected to the other of the terminals 60b through a metallic film 74. The heater 58 is electrically connected to the pair of terminals 60c through metallic films.

The magnetic head 33 configured as described above is attached to the distal end section of the suspension 30, i.e., to the gimbal 76 as shown in FIG. 4. That is, the back surface of the substrate 42a constituting the slider 42 is attached to the gimbal 76 by means of silver paste 77 or the like. As a result of this, the slider 42 is fixed to the gimbal 76 and suspension 30, and is also electrically connected to the gimbal 76 and suspension 30. The suspension 30 is electrically connected to the base 11 serving as the ground through the above-mentioned arm and bearing section.

A trace 80 including a relay FPC 78 is fixed on the suspension 30. The relay FPC 78 includes a plurality of, in this case, six wires extending from the extension end of the suspension 30 to the vicinity of the bearing section 24 through the suspension and arm. Distal ends of the wires are electrically connected to the terminals 60a, 60b, and 60c of the magnetic head 33 by using a connection material such as solder or the like. Further, the other ends of the wires are connected to the preamplifier 37 (FIG. 1) of the board unit 17 through the main FPC 38. Regarding the preamplifier 37, power source lines, signal lines for read/write, and signal lines for reproduction/recording operation control are electrically connected to the control circuit board through the FPC.

According to the HDD configured in the manner described above, by driving the VCM 15, the head actuator 14 is rotated, magnetic head 33 is moved to a desired track of the magnetic disk 12, and is positioned thereon. Further, the magnetic head 33 is floated by an airflow C generated between the disk surface and the disk-facing surface 43 by the rotation of the magnetic disk 12. During the HDD operation, the disk-facing surface 43 of the slider 42 is opposed to the disk surface with a gap held between them. As shown in FIG. 2, the magnetic head 33 is floated assuming a posture in which the head section 44 is the closest to the surface of the magnetic disk 12. In this state, recorded information is read from the magnetic disk 12 by the reproduction element 54, and information is written to the magnetic disk 12 by the recording head 56.

As shown in FIGS. 4 and 5, at the information reproduction time, in the state where recording current is not applied to the recording coil 70, the reproduction element 54 protrudes to be closer to the magnetic disk 12 side than the recording element 56, and is positioned close to the magnetic disk surface. Furthermore, by applying a current to the heater 58 to generate heat, the reproduction element 54 and recording element 56 are heated and expanded, and are both caused to protrude toward the magnetic disk 12 surface. At this time, the recording element 56 and reproduction element 54 are formed in such a manner that both the elements 56 and 54 have substantially the same thermal expansion coefficient, and hence both the elements 56 and 54 thermally expand by substantially the same amount to protrude toward the magnetic disk 12 surface side. As a result of this, even in the state where the elements 56 and 54 are heated by the heater 58, the positional relationship in which the reproduction element 54 protrudes to be closer to the magnetic disk 12 surface side than the recording element 56 is maintained. As a result of this, it is possible to make the reproduction element 54 closer to the magnetic disk surface without the possibility of the recording element 56 coming into contact with the magnetic disk surface earlier. In this state, by making the reproduction element 54 read the recorded information from the magnetic disk 12, it is possible to read the recorded signal of the magnetic disk 12 with a higher signal-to-noise ratio.

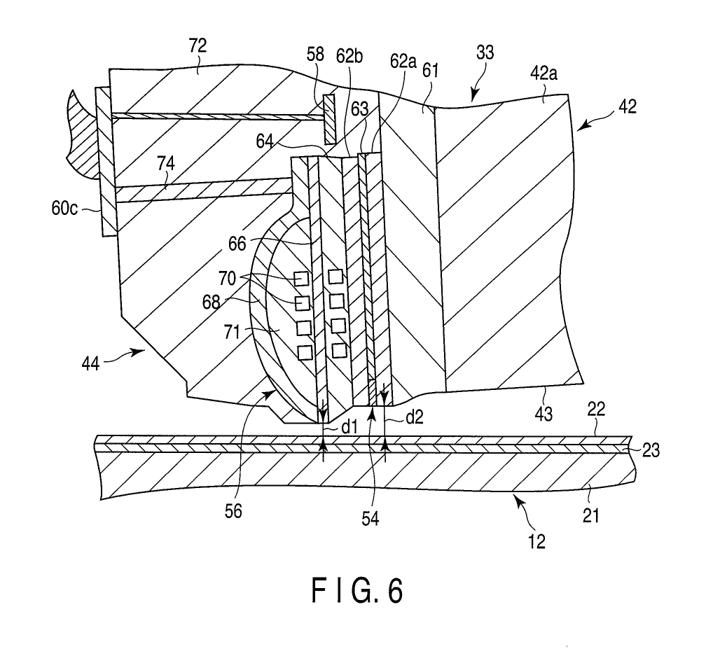

In an information write operation, when a recording current (Iw2) with an amplitude exceeding the recording current (Iw1) with a predetermined amplitude is applied to the recording coil 70, the main magnetic pole 66 is excited by the recording coil 70. As a result of this, a recording magnetic field in the vertical direction is applied to the recording layer 22 of the magnetic disk 12 directly under the main magnetic pole 66, and information is recorded with a desired track width. At this time, by the application of the current to the recording coil 70, the recording coil and main magnetic pole 66 are heated. As a result of this, as shown in FIG. 6, the main magnetic pole 66 is thermally expanded toward the magnetic disk 12 surface, and is protruded to be closer to the magnetic disk 12 surface than the reproduction element 54. That is, the recording element 56 and reproduction element 54 are positioned in such a manner that a distance d1 between the recording element 56 and disk surface is less than a distance d2 between the reproduction element 54 and disk surface, whereby the recording element 56 is positioned to protrude more than the reproduction element 54. As a result of this, it becomes possible to carry out signal recording in the state where the recording element 56 is made closer to the magnetic disk 12 surface, and carry out write at higher magnetic field intensity.

It should be noted that the above state is employed when the distance between the recording element 56 and magnetic disk 12 surface is measured in the manufacturing process of the drive. As described previously, in the state where a recording current (Iw2) with an amplitude exceeding the recording current (Iw1) with a predetermined amplitude is applied to the recording coil 70, a current is applied to the heater 58 to be heated, the recording element 56 is brought into contact with the magnetic disk 12 surface, and the distance between the recording element 56 and magnetic disk 12 surface is measured. At this time, it is possible to prevent the reproduction element 54 from coming into contact with the magnetic disk 12, prevent the protective film of the reproduction element 54 from being damaged, and prevent ESD breakdown from occurring.

Next, a method of manufacturing the above-mentioned magnetic head will be described.

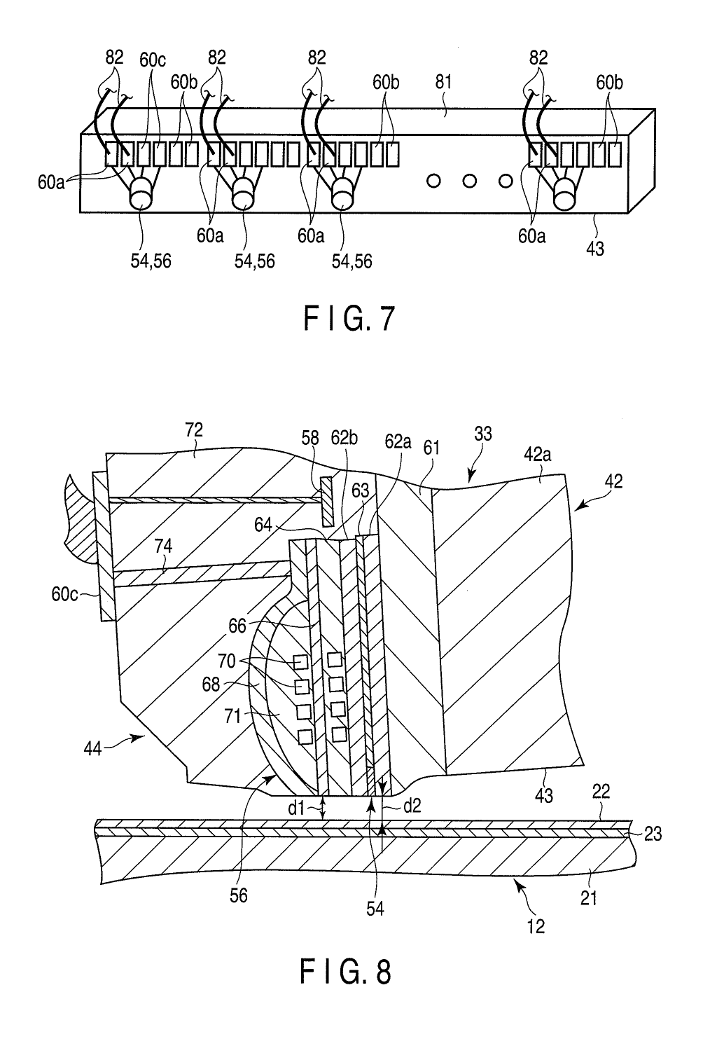

FIG. 7 shows a rod-shaped body processed from a wafer in which a plurality of magnetic heads are incorporated to a state where a plurality of sliders are arranged thereon in a line. In this rod-shaped body 81, each of recording elements 56 and reproduction elements 54 is connected to a corresponding one of terminals 60a, 60b, and 60c through a lead wire. In order to determine the element height, the disk-facing surface (ABS) 43 which is the undersurface of the rod-shaped body 81 is subjected to a lapping process (polishing process). When the lapping process is carried out, a probe 82 for current application to the recording element is connected in advance to each terminal 60a for the recording element.

Further, in a state where a predetermined recording current Iw3 is applied to each recording element 56 through each probe 82 and each terminal 60a, i.e., in a state where each main magnetic pole 66 is made to protrude from the disk-facing surface 43 by an amount greater than each reproduction element 54 by applying a current to the recording coil 70 of each recording element 56, and by heating/expanding each main magnetic pole 66 and each return magnetic pole part, the disk-facing surface 43 is subject to the lapping process. By lapping the part of the main magnetic pole 66 protruded by the thermal expansion, and distal end part of the reproduction element 54, the main magnetic pole and reproduction element are processed in such a manner that the main magnetic pole and reproduction element are equal to each other in height, i.e., flush with each other as shown in FIG. 8.

After the lapping process, the application of the current to each recording element 56 is stopped, whereby the rod-shaped body is brought into a state where each main magnetic pole 66 is contracted, and is recessed from each reproduction element 54. Thereafter, the rod-shaped body 81 is cut into a plurality of sliders, and is formed into a plurality of magnetic heads. As a result of this, a magnetic head of the above-mentioned configuration is obtained. In order to optimize the protrusion/depression relationship between the recording element 56 and reproduction element 54, the lapping process may be carried out while a current is applied to the heater 58.

It should be noted that the recording current Iw3 to be applied to the recording element is of the value to be employed at the time of the manufacturing process, and corresponds to, in a magnetic head completed after the termination of the head manufacturing process, the recording current Iw1 configured to separate the recording element and reproduction element from the disk surface by distances substantially equal to each other when the magnetic head is actually used in an HDD. This is because the heat acting on the recording element and reproduction element at the time of the lapping process is associated with a heat flow different from the heat flow associated with the air cooling effect of the element when the magnetic head is floated.

When the recording current Iw1 is applied to the magnetic head 33 in the completed HDD, as shown in FIG. 8, substantially the same temperature as that at the time of the lapping process is obtained, and it is possible to make the protrusion height of the main magnetic pole 66 of the recording element 56 and that of the reproduction element equal to each other.

It should be noted that regarding the setting range of the recording current Iw1, the design value differs depending on the writing capability of the recording medium, shape of the main magnetic pole, and the like. Accordingly, in order to obtain the state where the protrusion heights of the main magnetic pole 66 and reproduction element 54 become equal to each other as shown in FIG. 8, assuming that the current value necessary for the actual operation of the recording element 56 at the environmental temperature at the lapping process time is in the range of 12 to 30 mA, the recording current Iw1 is set at a value less than the lower limit value of the necessary current, in this case, at a value less than or equal to 12 mA.

According to the magnetic head 33 configured as described above, and HDD provided with the magnetic head 33, it is possible to, at the information reproduction time, make the reproduction element protrude to be closer to the magnetic disk surface than the recording element and, at the information recording time, make the recording element protrude to be closer to the magnetic disk surface side than the reproduction element. As a result of this, it is possible to obtain a high-performance reliability-improved magnetic head, and disk apparatus provided with the magnetic head which are capable of carrying out signal write at a higher magnetic field intensity, securing a reproduction signal signal-to-noise ratio necessary for the high recording density, and protecting the reproduction element.

The present invention is not limited to the above-mentioned embodiment as it is, and in the implementation stage, the constituent elements may be modified and embodied within the scope not deviating from the gist of the invention. Further, by appropriately combining a plurality of constituent elements disclosed in the above embodiment, various inventions can be formed. For example, some constituent elements may be deleted from all the constituent elements shown in the embodiment. Furthermore, constituent elements of different embodiments may be appropriately combined.

For example, the material, shape, size, and the like of the elements constituting the head section can be changed as the need arises. Further, in the magnetic disk apparatus, the number of magnetic disks or magnetic heads can be increased as the need arises, and size of the magnetic disk can be variously selected. The magnetic head according to the present invention is not limited to the magnetic head for vertical magnetic recording, and the invention can be applied to the other type of magnetic head.

What is claimed is:

1. A magnetic head comprising:
a recording element configured to record information on a recording medium;
a reproduction element configured to reproduce recorded information from the recording medium; and
a heater configured to heat the recording element and reproduction element and to cause the elements to thermally expand toward the recording medium side,
wherein a distance between the recording element and the recording medium surface is longer than a distance between the reproduction element and recording medium surface if a recording current with an amplitude smaller than or equal to a predetermined amplitude is applied to the recording element, and the distance between the recording element and the recording medium surface is shorter than the distance between a surface of the reproduction element and the recording medium surface if a recording current with an amplitude larger than the predetermined amplitude is applied to the recording element.

2. The magnetic head of claim 1, wherein the recording element and reproduction element comprise a common thermal expansion coefficient.

3. The magnetic head of claim 1, wherein a thermal expansion coefficient of the recording element is greater than a thermal expansion coefficient of the reproduction element.

4. The magnetic head of claim 1, wherein the heater is a single heater configured to simultaneously heat the recording element and reproduction element.

5. The magnetic head of claim 1, wherein the recording element comprises a main magnetic pole configured to apply a recording magnetic field perpendicular to the recording medium surface to the recording medium, and a recording coil configured to excite the main magnetic pole.

6. The magnetic head of claim 1, further comprising a slider configured to face the surface of the recording medium, wherein the recording element and the reproduction element are on the slider and exposed at the medium-facing surface.

7. A disk apparatus comprising:
a disk-shaped recording medium comprising a recording layer;
a driving module configured to rotate the recording medium; and
a magnetic head configured to read data from the recording medium and to write data to the recording medium,
the magnetic head comprising:
a recording element configured to record information on the recording medium;
a reproduction element configured to reproduce recorded information from the recording medium; and
a heater configured to heat the recording element and reproduction element and cause the elements to thermally expand toward the recording medium side,
wherein a distance between the recording element and the recording medium surface is greater than a distance between the reproduction element and recording medium surface if a recording current with an amplitude smaller than or equal to a predetermined amplitude is applied to the recording element, and the distance between the recording element and the recording medium surface is shorter than the distance between a surface of the reproduction element and the recording medium surface if a recording current of an amplitude larger than the predetermined amplitude is applied to the recording element.
